(19) United States
(12) Patent Application Publication
(10) Pub. No.: US 2026/0112853 A1
(43) Pub. Date: Apr. 23, 2026

(54) POWER SUPPLY ADAPTER STRUCTURE FOR HEATED CLOTHING

(71) Applicant: Guangzhou Issyzone Technology Co.,Limited, Guangzhou (CN)

(72) Inventors: TAIPING YANG, Guangzhou City (CN); YALEI ZHU, Guangzhou City (CN)

(21) Appl. No.: 18/991,565

(22) Filed: Dec. 22, 2024

(30) Foreign Application Priority Data
Oct. 18, 2024 (CN) 2024225273990

(51) Int. Cl. H01R 31/06

(52) U.S. Cl. CPC H01R 31/065

(57) ABSTRACT

This utility model discloses a power supply adapter structure for heated clothing, the power supply adapter structure including: a connector at least including a base, a DC socket and a type-C socket disposed on different sides of the base and connected in parallel, and a PD protocol chip encapsulated inside the base and having a signal handshaking terminal connected to a signal handshaking terminal of the type-C socket; and a wire connected, at one end, to output terminals of the DC socket and the type-C socket and connected, at the other end, to a heating unit. The PD protocol chip is an FS312BL PD handshake protocol chip. This utility model has the following beneficial effects.

### CROSS REFERENCE TO RELATED APPLICATIONS

The present application claims the priority of Chinese patent application No. 2024225273990, filed on Oct. 18, 2024, and contents of which are incorporated herein by reference.

### BACKGROUND OF THE INVENTION

### Field of the Invention

This utility model relates to the technical field of heated clothing accessories, and in particular to a power supply adapter structure for heated clothing.

### Description of Related Art

A power supply system for heated clothing in the related art substantially uses a USB or a DC power plug to supply power, but both of these power supply heads have obvious disadvantages.

For example, the common USB power supply protocol can only request a voltage of 5 V from a mobile power supply, and when a load requests higher power, the mobile power supply is decreased in a discharge efficiency and generates severe heat. In addition, many mobile power supplies are set with peak output power at the factory, and can only provide 5 V*3 A, that is, 15 W of power at most. Since a DC interface has no protocol regulations, a power plug thereof can freely choose to use a voltage of 5 V, 7.4 V, 12 V, or even 20 V. A high voltage solution can effectively alleviate the heating of the mobile power supply, but a DC solution requires an output voltage of the mobile power supply to be specially customized, resulting in a one-to-one binding between the heated clothing and the mobile power supply, and thus if the mobile power supply is lost or damaged, it is difficult for a user to quickly purchase a suitable mobile power supply.

In view of this, decoy cable products have appeared on the market. A principle of a DC decoy adapter is based on a handshake mechanism of a PD protocol chip. When the DC decoy adapter is connected to a PD charger (or mobile power supply), a PD chip on a powered side handshakes with a chip of the charger. In response to the successful handshake, the charger outputs a correct voltage as required. C:\Users\markg\OneDrive-W & K IP\W&K Patent Application cases\Utility Patent Applications\WKIP\CA24-060-SZMS-028 (Yang Taiping)\ This mechanism enables the DC decoy adapter to decoy a voltage of 5 V, 9 V, 12 V, 15 V, 18 V, 20 V, or the like from a charging head that supports the USB PD/QC protocol so as to provide fast power supply or fast charging for a device.

However, a 12 V decoy cable in the related art has a structure in which a USB port and a DC port are set at an input terminal and an output terminal, which is a detachable structure at both ends, and is not suitable for heated clothing. In addition, there is only one USB port at the input terminal of the 12 V decoy cable. Similarly, if the mobile power supply is lost or damaged, it is difficult for a user to quickly purchase a suitable mobile power supply.

### SUMMARY

In view of the above problems, this utility model provides a power supply adapter structure for heated clothing, which mainly solves the problem of insufficient universality of a voltage decoy cable in the related art.

In order to solve the above problems, technical solutions of this utility model are as follows.

A power supply adapter structure for heated clothing, the power supply adapter structure including:
a connector at least including a base, a DC socket and a type-C socket disposed on different sides of the base and connected in parallel, and a PD protocol chip encapsulated inside the base and having a signal handshaking terminal connected to a signal handshaking terminal of the type-C socket; and
a wire connected, at one end, to an output terminal of the PD protocol chip and connected, at the other end, to a heating unit.

In some embodiments, the PD protocol chip is an FS312BL PD handshake protocol chip.

In some embodiments, a differential signal positive electrode D+ of the type-C socket is connected to a signal terminal DP of the PD protocol chip, a differential signal negative electrode D− of the type-C socket is connected to a signal terminal DM of the PD protocol chip, a detection pin CC1 of the type-C socket is grounded through a resistor R3 and a diode D1 in sequence, a negative electrode of the diode D1 points to the resistor R3 and is connected to a detection terminal CC1 of the PD protocol chip, a bus power supply VBUS of the type-C socket and a positive electrode of the DC socket are connected in parallel and then connected to one end of the heating unit, and the other end of the heating unit and a negative electrode of the DC socket are grounded.

In some embodiments, the bus power supply VBUS of the type-C socket is grounded via a resistor R1 and a diode D2, a negative electrode of the diode D2 points to the resistor R1, and a power supply terminal VDD of the PD protocol chip is connected to the negative electrode of the diode D2, and is grounded via a capacitor C1.

In some embodiments, a control terminal FUNC of the PD protocol chip is grounded via a resistor R2.

This utility model has the following beneficial effects. By setting the DC socket and the type-C socket in parallel, an output voltage of a 12 V dedicated mobile power supply is input into the heating unit through the DC socket, and the type-C socket and the PD protocol chip are used to perform decoy on a universal mobile power supply to output the voltage of 12 V and input the voltage into the heating unit, so that heated clothing can adapt to more mobile power supplies, and the user experience is improved.

### BRIEF DESCRIPTION OF THE DRAWINGS

FIG. 1 is a three-dimensional diagram of a power supply adapter structure for heated clothing disclosed in an embodiment of this utility model.

FIG. 2 is a circuit schematic diagram of a DC socket, a type-C socket, and a PD protocol chip disclosed in the embodiment of this utility model.

### DESCRIPTION OF EMBODIMENTS

In order to make an object, technical solutions, and advantages of this utility model clearer and more specific, the content of this utility model is further described in detail in combination with the drawings and embodiments. It is understandable that the embodiments described here are merely used to describe this utility model, not to limit this utility model. It should be noted that, for the convenience of description, only parts related to this utility model are shown in the drawings, not all of the contents.

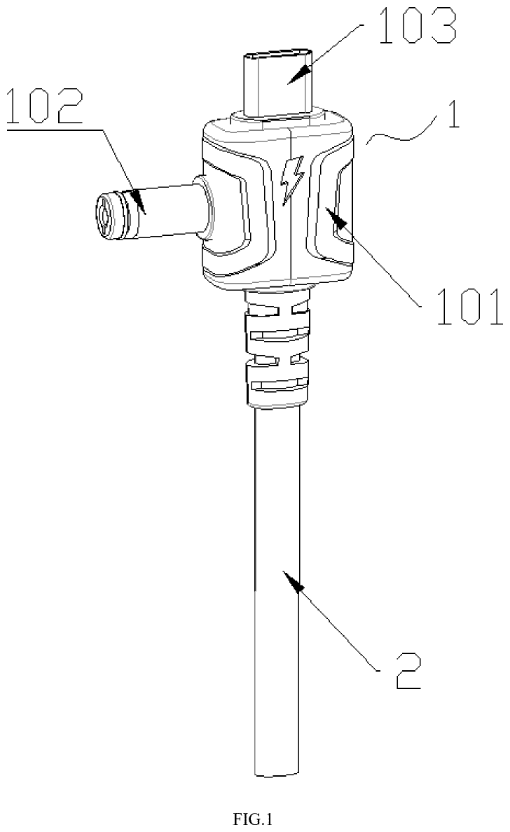

The present embodiment relates to a power supply adapter structure for heated clothing, and as shown in FIG. 1, the power supply adapter structure including:
a connector 1 at least including a base 101, a DC socket 102 and a type-C socket 103 disposed on different sides of the base and connected in parallel, and a PD protocol chip (not shown) encapsulated inside the base 101 and having a signal handshaking terminal connected to a signal handshaking terminal of the type-C socket 103; and
a wire 2 connected, at one end, to an output terminal of the PD protocol chip and connected, at the other end, to a heating unit (not shown, omitted) in an undetachable manner.

In the present embodiment, by setting the DC socket and the type-C socket in parallel, an output voltage of a 12 V dedicated mobile power supply is input into the heating unit through the DC socket, and the type-C socket and the PD protocol chip are used to perform decoy on a universal mobile power supply to output the voltage of 12 V and input the voltage into the heating unit, so that heated clothing can adapt to more mobile power supplies, and the user experience is improved.

The above PD protocol chip may be any integrated circuit chip that supports the PD protocol. Hereinafter, an FS312BL PD handshake protocol chip and a 24-pin type-C socket are adopted and specifically described.

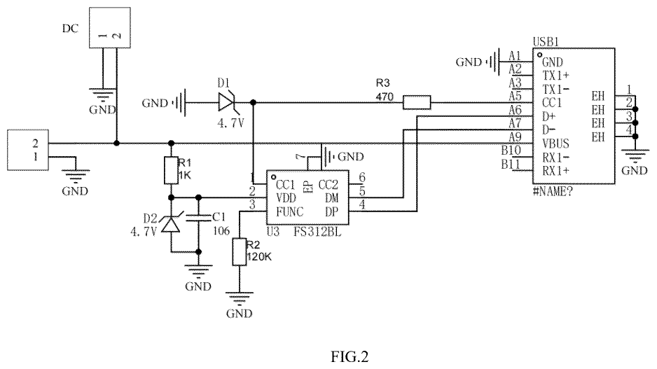

As shown in FIG. 2 and Table 1, a differential signal positive electrode D+ of the type-C socket is connected to a signal terminal DP of the PD protocol chip, a differential signal negative electrode D− of the type-C socket is connected to a signal terminal DM of the PD protocol chip, a detection pin CC1 of the type-C socket is grounded through a resistor R3 and a diode D1 in sequence, a negative electrode of the diode D1 points to the resistor R3 and is connected to a detection terminal CC1 of the PD protocol chip, a bus power supply VBUS of the type-C socket and a positive electrode of the DC socket are connected in parallel and then connected to one end of the heating unit, and the other end of the heating unit and a negative electrode of the DC socket are grounded. The differential signal positive electrode D+, the differential signal negative electrode D−, and the detection pin CC1 described above can be considered as the signal handshaking terminals of the type-C socket 103, and correspondingly, the signal terminal DP, the signal terminal DM, and the detection terminal CC1 can be considered as the signal handshaking terminals of the PD protocol chip.

TABLE 1
Definition of Type-C Pin

| Code of pin | Definition of pin |
|---|---|
| A1 | GND |
| A2 | TX1+ |
| A3 | TX1− |
| A4 | Vbus |
| A5 | CC1 |
| A6 | D+ |
| A7 | D− |
| A8 | SBU1 |
| A9 | Vbus |
| A10 | RX2− |
| A11 | RX2+ |
| A12 | GND |
| B1 | GND |
| B2 | TX2+ |
| B3 | TX2− |
| B4 | Vbus |
| B5 | CC2 |
| B6 | D+ |
| B7 | D− |
| B8 | SBU2 |
| B9 | Vbus |
| B10 | RX1− |
| B11 | RX1+ |
| B12 | GND |

In the above solution, the A6 and A7 ports (positive and negative differential signals) of the type-C socket provide differential signals to the FS312BL PD handshake protocol chip, and perform decoy on the chip to provide different input voltages and currents according to requirements of a device, thereby achieving a faster charging speed. The A5 port (detection pin CC1) of the type-C socket is connected to the detection terminal CC1 of the FS312BL PD handshake protocol chip to check reversible insertion of the type-C socket and the PD fast charging protocol. The diode D1 is set before a ground terminal GND, and the negative electrode of the diode D1 points to the resistor R3. When a power supply is connected in reverse, a reverse blocking characteristic of the diode D1 can prevent the current from entering the circuit, thereby protecting components in the circuit from damage. A charging protocol chip of an external power supply is coupled with the signal handshaking terminal of the PD protocol chip via the signal handshaking terminal of the type-C socket 103. In response to the protocol handshake, the external power supply outputs an expected voltage to the bus power supply VBUS of the type-C socket. Finally, the bus power supply VBUS of the type-C socket and the positive electrode of the DC socket are connected in parallel and then connected to one end of the heating unit. Since the connector 1 of this solution is designed to be compact, there is only one socket with power input at one time. For example, the voltage output from A5 (bus power supply VBUS) of the type-C socket is directly output to the heating unit, and the external voltage of 12 V is directly input to the heating unit through the DC socket.

Specifically, the bus power supply VBUS of the type-C socket is grounded via a resistor R1 and a diode D2, a negative electrode of the diode D2 points to the resistor R1, and a power supply terminal VDD of the PD protocol chip is connected to the negative electrode of the diode D2, and is grounded via a capacitor C1. Obviously, based on the above solution, the voltage output by the bus power supply VBUS of the type-C socket is also used as a power supply of the PD protocol chip, is limited by being connected to the resistor R1 in parallel, and is input to the power supply terminal VDD of the PD protocol chip.

A control terminal FUNC of the PD protocol chip is grounded via a resistor R2.

The above embodiments merely describe the technical concept and characteristics of this utility model, and an object thereof is to enable those skilled in the art to understand the content of this utility model and implement the same, and does not limit the protection scope of this utility model. Any equivalent changes or modifications made according to the substance of the content of this utility model should be included in the protection scope of this utility model.

This utility model discloses a power supply adapter structure for heated clothing, the power supply adapter structure including: a connector at least including a base, a DC socket and a type-C socket disposed on different sides of the base and connected in parallel, and a PD protocol chip encapsulated inside the base and having a signal handshaking terminal connected to a signal handshaking terminal of the type-C socket; and a wire connected, at one end, to output terminals of the DC socket and the type-C socket and connected, at the other end, to a heating unit. The PD protocol chip is an FS312BL PD handshake protocol chip. This utility model has the following beneficial effects. By setting the DC socket and the type-C socket in parallel, an output voltage of a 12 V dedicated mobile power supply is input into the heating unit through the DC socket, and the type-C socket and the PD protocol chip are used to perform decoy on a universal mobile power supply to output the voltage of 12 V and input the voltage into the heating unit, so that heated clothing can adapt to more mobile power supplies, and the user experience is improved.

What is claimed is:

1. A power supply adapter structure for heated clothing, the power supply adapter structure comprising:
a connector at least including a base, a DC socket and a type-C socket disposed on different sides of the base and connected in parallel, and a PD protocol chip encapsulated inside the base and having a signal handshaking terminal connected to a signal handshaking terminal of the type-C socket; and
a wire connected, at one end, to output terminals of the DC socket and the type-C socket and connected, at the other end, to a heating unit.

2. The power supply adapter structure for heated clothing according to claim 1, wherein the PD protocol chip is an FS312BL PD handshake protocol chip.

3. The power supply adapter structure for heated clothing according to claim 1, wherein a differential signal positive electrode D+ of the type-C socket is connected to a signal terminal DP of the PD protocol chip, a differential signal negative electrode D− of the type-C socket is connected to a signal terminal DM of the PD protocol chip, a detection pin CC1 of the type-C socket is grounded through a resistor R3 and a diode D1 in sequence, a negative electrode of the diode D1 points to the resistor R3 and is connected to a detection terminal CC1 of the PD protocol chip, a bus power supply VBUS of the type-C socket and a positive electrode of the DC socket are connected in parallel and then connected to one end of the heating unit, and the other end of the heating unit and a negative electrode of the DC socket are grounded.

4. The power supply adapter structure for heated clothing according to claim 3, wherein the bus power supply VBUS of the type-C socket is grounded via a resistor R1 and a diode D2, a negative electrode of the diode D2 points to the resistor R1, and a power supply terminal VDD of the PD protocol chip is connected to the negative electrode of the diode D2, and is grounded via a capacitor C1.

5. The power supply adapter structure for heated clothing according to claim 2, wherein a control terminal FUNC of the PD protocol chip is grounded via a resistor R2.
